(19) United States
(12) Patent Application Publication
(10) Pub. No.: US 2014/0179273 A1
(43) Pub. Date: Jun. 26, 2014

(54) LOCATION-BASED AUTHENTICATION SCHEME

(71) Applicants: Seungil Kim, Seoul (KR); Youngil Ko, Seoul (KR)

(72) Inventors: Seungil Kim, Seoul (KR); Youngil Ko, Seoul (KR)

(73) Assignee: Empire Technology Development LLC, Wilmington, DE (US)

(21) Appl. No.: 13/980,968

(22) PCT Filed: Dec. 21, 2012
(86) PCT No.: PCT/US2012/071158

§ 371 Date: Jul. 22, 2013

(51) Int. Cl. H04W 12/06; H04W 4/02

(52) U.S. Cl. CPC H04W 12/06; H04W 4/025
USPC 455/411

(57) ABSTRACT

Technologies are generally described for a location-based authentication scheme. In some examples, a method performed under control of a server may include receiving a first notification of a first use of an application, determining a first location of a first device corresponding to the first use, receiving a second notification of a second use of the application, determining a second location of a second device corresponding to the second use, determining whether the second location is within a predetermined range from the first location, and enabling execution of the second use in response to determining that the second location is within the predetermined range from the first location.

### BACKGROUND

Development of applications has become one of the largest industries related to mobile device technologies. There are a number of business models for generating revenue from the applications. The most obvious way to generate revenue from the applications is to sell the applications to users, but there are also many other ways to monetize the applications. For example, application developers/providers may incorporate advertisements inside the applications, sell additional content, items or features to the users via in-app purchase, induce the users to subscribe to paid services, and/or provide the users with free trial versions in which some functions of the applications are restricted or the users can use the applications for a limited time and/or frequency.

### SUMMARY

In an example, a method performed under control of a server may include receiving a first notification of a first use of an application, determining a first location of a first device corresponding to the first use, receiving a second notification of a second use of the application, determining a second location of a second device corresponding to the second use, determining that the second location is within a predetermined range from the first location, and enabling execution of the second use.

In an example, a method performed under control of a device may include registering a first location, receiving a request to authorize execution of an application, determining a second location of the device, determining that the second location is within a predetermined range from the first location, and authorizing execution of the application.

In an example, a server for providing location-based authentication may include an input receiving unit configured to receive a first notification of a first use of an application and a second notification of a second use of the application; a location determination unit configured to determine a first location of a first device corresponding to the first use, and further configured to determine a second location of a second device corresponding to the second use; and an authentication unit configured to authorize execution of the second use based at least in part on the first location and the second location.

In an example, a device for providing location-based authentication may include a location registration unit configured to register a first location, an input receiving unit configured to receive a request to authorize execution of an application, a location determination unit configured to determine a second location of the device, and an authentication unit configured to authorize execution of the application based at least in part on the first location registered by the location registration unit and the second location determined by the location determination unit.

In an example, a computer-readable storage medium may store thereon computer-executable instructions that, in response to execution, cause a processor to perform operations, including registering a first location, determining a second location of a device when detecting a request to authorize execution of an application, determining that the second location is within a predetermined range from the first location, and authorizing execution of the application on the device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows an illustrative example of an environment in which a server implements a location-based authentication scheme for multiple devices, arranged in accordance with at least some embodiments described herein;

FIG. 2 shows a schematic block diagram illustrating an example architecture of a server for implementing a location-based authentication scheme, arranged in accordance with at least some embodiments described herein;

FIG. 3 shows an example flow diagram of a process for a server implementing a location-based authentication scheme, arranged in accordance with at least some embodiments described herein;

FIG. 4 shows a schematic block diagram illustrating an example architecture of a device for implementing a location-based authentication scheme, arranged in accordance with at least some embodiments described herein;

FIG. 5 shows an example flow diagram of a process for a device implementing a location-based authentication scheme, arranged in accordance with at least some embodiments described herein;

FIG. 6 illustrates an example computer program product that may be utilized to implement a location-based authentication scheme, arranged in accordance with at least some embodiments described herein; and

FIG. 7 is a block diagram illustrating an example computing device that may be utilized to implement a location-based authentication scheme, arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the drawings, can be arranged, substituted, combined, separated, and designed in a wide variety of different configurations, all of which are explicitly contemplated herein.

This disclosure is generally drawn, inter alia, to methods, apparatuses, systems, devices, and computer program products related to a location-based authentication scheme. Further, technologies are herein generally described for allowing users to use the applications in limited areas.

In some examples, a user, who may own and/or exercise control over one or more devices, may be interested in executing an application on one or more of his/her devices. In such cases, the user may try downloading the application from a server to at least one of his/her devices, installing the application on the at least one device, and executing the application on the at least one device. The server, which may be operated by a developer or provider of the application, may allow the user to use the application in a limited area, and induce the user to buy the application when the user desires to use the application outside the limited area (i.e., anywhere).

In some examples, the server may receive from one of the devices (i.e., a first device) a first notification of a first use of the application. By way of example, but not limitation, the first use may include initially downloading the application from the server to the first device, initially installing the application on the first device, or initially executing the application on the first device. Then, the server may determine a first location of the first device based at least in part on a GPS (Global Positioning System) coordinate of the first device, cell information of a cellular network accessed by the first device, and/or Wi-Fi access point information of the first device. Then, the server may register the first location, and establish a boundary within which the user may be able to use the application based at least in part on the first location. By way of example, but not limitation, the server may enable execution of the application on the first device when the first device is located within a predetermined range from the first location. That is, the user may execute the application on the first device within the predetermined range from the first location. If the user wants to execute the application on another device (i.e., a second device), the server may also enable execution of the application on the second device when the second device is located within the predetermined range from the first location.

In some examples, when the server enables the execution of the application on the first or second device, the server may monitor movement of the first or second device. In such cases, the server may determine whether the first or second device moves beyond the predetermined range during the execution of the application. Then, when the server determines that the first or second device has moved beyond the predetermined range, the server may disable the execution of the application.

In some examples, when the server determines that the first or second device is not within the predetermined range from the first location, the server may provide the first or second device with a notice suggesting purchase of the application.

In some alternative examples, one of the devices (i.e., a third device) may register the first location, and may authorize execution of the application within a predetermined range from the first location. By way of example, but not limitation, the third device may register the first location based at least in part on information regarding the first location received from the server. By way of another example, but not limitation, the third device may determine the first location as a location of the third device when performing at least one of initially downloading the application from the server to the third device, initially installing the application on the third device, or initially executing the application on the third device, depending on a desired implementation.

In some examples, when authorizing the execution of the application, the third device may monitor its own movement, and determine whether the third device has moved beyond the predetermined range during the execution of the application. When the third device determines that it has moved beyond the predetermined range, the third device may disable the execution of the application.

In some examples, when the third device determines that it is not within the predetermined range from the first location, the third device may display a notice suggesting purchase of the application.

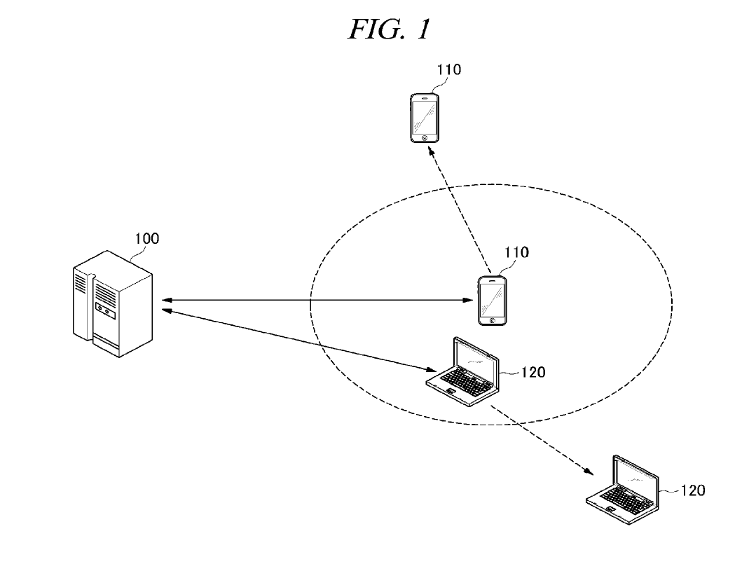

FIG. 1 schematically shows an illustrative example of an environment in which a server 100 implements a location-based authentication scheme for multiple devices 110 and 120, arranged in accordance with at least some embodiments described herein.

As depicted, server 100 may interact with devices 110 and 120 so that the user of devices 110 and 120 may download an application from server 100 onto devices 110 and/or 120, install the application on devices 110 and/or 120, and/or execute the application on devices 110 and/or 120. The user may have an account for accessing server 100, and thus may have his/her devices 110 and 120 access server 100 using the account.

By way of example, but not limitation, server 100 may be operated or controlled by a developer and/or provider of the application. By way of example, but not limitation, devices 110 and/or 120 may respectively include a smartphone, a mobile phone, a personal digital assistant (PDA), a tablet, a laptop computer, etc. Server 100 and devices 110, 120 may communicate with each other via a network such as, for example, a wide area network (WAN), a metropolitan area network (MAN), a local area network (LAN), a campus area network (CAN), a virtual private network (VPN), etc. Although the below description describes that server 100 and/or devices 110, 120 perform several operations and/or functions in accordance with at least some embodiments, those skilled in the art will recognize that computer programs or program modules hosted by the respective entities may perform the operations and/or functions described herein.

In some embodiments, server 100 may receive a first notification of a first use of the application. The first use may include, but is not limited to, initially downloading the application from server 100 to device 110 or 120, initially installing the application on device 110 or 120, or initially executing the application on device 110 or 120. In accordance with at least one example embodiment, the below description may assume that the first use may be associated with device 110; that is, the first use may include initially downloading the application from server 100 to device 110, initially installing the application on device 110, or initially executing the application on device 110.

Then, in some example embodiments, server 100 may determine a first location of device 110 at the time of the first use. By way of example, but not limitation, server 100 may determine the first location based at least in part on a GPS (Global Positioning System) coordinate of device 110, cell information of a cellular network accessed by device 110, and/or Wi-Fi access point information of device 110 when receiving the first notification.

In some embodiments, server 100 may register the first location. The first location may serve as a reference location for providing the location-based authentication scheme.

In some embodiments, server 100 may receive a second notification pertaining to a second use of the application. The second use may include, but is not limited to, executing the application on device 110 or 120. In accordance with at least one example embodiment, the below description may assume that the second use may be associated with device 120, that is, the second use may include executing the application on device 120.

Then, in some embodiments, server 100 may determine a second location of device 120 corresponding to the second use. By way of example, but not limitation, server 100 may determine the second location based at least in part on a GPS coordinate of device 120, cell information of a cellular network accessed by device 120, and/or Wi-Fi access point information of device 120 when receiving the second notification.

Then, in some embodiments, server 100 may determine whether the second location is within a predetermined range from the first location, and enable execution of the second use on device 120 in response to determining that the second location is within the predetermined range from the first location.

By way of example, but not limitation, server 100 may identify a first GPS coordinate of device 110 when receiving the first notification, identify a second GPS coordinate of device 120 when receiving the second notification, and calculate a distance between the first location and the second location based at least in part on the first GPS coordinate and the second GPS coordinate. Then, server 100 may determine whether the distance is within the predetermined range.

By way of another example, but not limitation, server 100 may identify first cell information of a cellular network accessed by device 110 when receiving the first notification, identify second cell information of the cellular network accessed by device 120 when receiving the second notification, and calculate the distance between the first location and the second location based at least in part on the first cell information and the second cell information. Then, server 100 may determine whether the distance is within the predetermined range.

By way of yet another example, but not limitation, server 100 may identify a first cell of the cellular network in which device 110 is located when receiving the first notification, and identify a second cell of the cellular network in which device 120 is located when receiving the second notification. Then, server 100 may determine that the second location is within the predetermined range from the first location when the first cell and the second cell are the same cell.

By way of still another example, but not limitation, server 100 may identify a first Wi-Fi access point accessed by device 110 when receiving the first notification, and identify a second Wi-Fi access point accessed by device 120 when receiving the second notification. Then, server 100 may determine that the second location is within the predetermined range from the first location when the first Wi-Fi access point and the second Wi-Fi access point are the same Wi-Fi access point.

In some embodiments, when server 100 determines that the second location is not within the predetermined range from the first location, server 100 may provide device 120 with a notice suggesting purchase of the application. By way of example, but not limitation, device 120 may display the notice as a pop-up on a browser or SMS (Short Message Service) text message.

In some embodiments, after enabling the execution of the second use on device 120, server 100 may monitor movement of device 120. Then, server 100 may determine whether device 120 has moved beyond the predetermined range during the execution of the second use. When device 120 has moved beyond the predetermined range, server 100 may disable the execution of the second use on device 120.

Alternatively, in some embodiments, each of devices 110 and 120 may perform location-based authentication independently of server 100. That is, each of devices 110 and 120 may register the first location, receive a request to authorize execution of the application, determine the second location when receiving the request, determine whether the second location is within the predetermined range from the first location, and authorize execution of the application in response to determining that the second location is within the predetermined range from the first location. Each of devices 110 and 120 may receive information regarding the first location from server 100, or determine the first location as a location of the corresponding device when at least one of initially downloading the application from server 100, initially installing the application, or initially executing the application is performed, depending on the desired implementation.

By way of example, but not limitation, each of devices 110 and 120 may identify a GPS coordinate when receiving the request, calculate the distance between the first location and the second location based at least in part on the identified GPS coordinate, and determine whether the distance is within the predetermined range.

By way of another example, but not limitation, each of devices 110 and 120 may identify cell information of a cellular network accessed by the corresponding device when receiving the request, calculate the distance between the first location and the second location based at least in part on the cell information, and determine whether the distance is within the predetermined range.

By way of yet another example, but not limitation, each of devices 110 and 120 may identify a cell of the cellular network in which the corresponding device is located when receiving the request, and determine that the second location is within the predetermined range from the first location when the identified cell and a cell associated with the first location are the same cell.

By way of still another example, but not limitation, each of devices 110 and 120 may identify a Wi-Fi access point accessed by the corresponding device when receiving the request, and determine that the second location is within the predetermined range from the first location when the identified Wi-Fi access point and a Wi-Fi access point associated with the first location are the same Wi-Fi access point.

In some embodiments, when device 110 or 120 determines that the second location is not within the predetermined range from the first location, it may display the notice suggesting purchase of the application.

In some embodiments, after authorizing the execution of the application, each of devices 110 and 120 may monitor its movement. Then, each of devices 110 and 120 may determine whether it has moved beyond the predetermined range during the execution of the application. When device 110 or 120 has moved beyond the predetermined range during the execution of the application, it may disable the execution of the application.

Although FIG. 1 illustrates that server 100 interacts with two devices 110 and 120, those skilled in the art will appreciate that server 100 may interact with any number of devices for providing the location-based authentication scheme. Also, although the above examples with reference to FIG. 1 are described under an assumption that the first use and the second use may be respectively associated with device 110 and device 120, those skilled in the art will appreciate that the first use and the second use may be associated with any of the user's one or more devices.

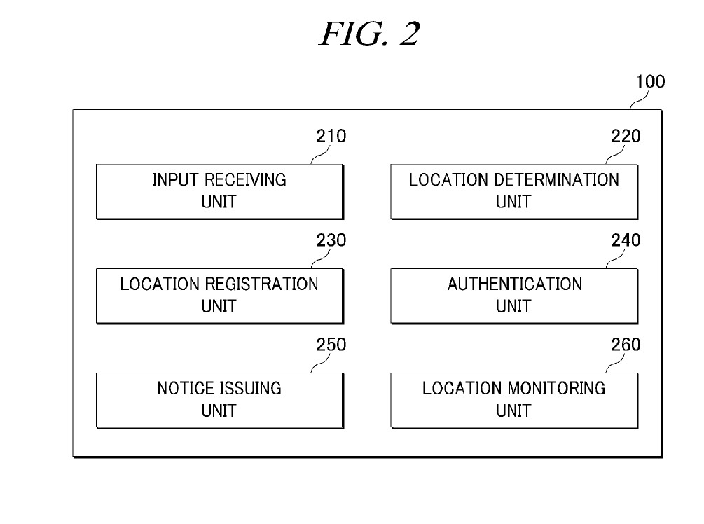

FIG. 2 shows a schematic block diagram illustrating an example architecture of a server 100 for implementing a location-based authentication scheme, arranged in accordance with at least some embodiments described herein.

In some embodiments, server 100 may provide an application to one or more devices including a first device (e.g., device 110 or 120) and a second device (e.g., device 110 or 120). Although the below description describes that server 100 interacts with two devices (i.e., the first device and the second device), those skilled in the art will appreciate that server 100 may interact with any number of devices for providing the location-based authentication scheme. Also, those skilled in the art will appreciate that the first device and the second device may be identical to each other in some embodiments.

As depicted in FIG. 2, server 100 may include an input receiving unit 210, a location determination unit 220, a location registration unit 230, an authentication unit 240, a notice issuing unit 250 and a location monitoring unit 260. Although illustrated as discrete components, various components may be divided into additional components, combined into fewer components, or eliminated while being contemplated within the scope of the disclosed subject matter. It will be understood by those skilled in the art that each function and/or operation of the components may be implemented, individually and/or collectively, by a wide range of hardware, software, firmware, or virtually any combination thereof.

Input receiving unit 210 may be configured to receive a first notification of a first use of the application and a second notification of a second use of the application. By way of example, but not limitation, the first use may include initially downloading the application from server 100 to the first device, initially installing the application on the first device, or initially executing the application on the first device. By way of example, but not limitation, the second use may include executing the application on the second device.

Location determination unit 220 may be configured to determine a first location of the first device corresponding to the first use, and further configured to determine a second location of the second device corresponding to the second use. By way of example, but not limitation, location determination unit 220 may determine the first location and/or the second location based at least in part on GPS (Global Positioning System) information, network cell information, and/or Wi-Fi access point information.

Location registration unit 230 may be configured to register or store therein the first location determined by location determination unit 220.

Authentication unit 240 may be configured to authorize execution of the second use based at least in part on the first location and the second location determined by location determination unit 220.

By way of example, but not limitation, location determination unit 220 may be configured to identify a first GPS coordinate of the first device when input receiving unit 210 receives the first notification, and identify a second GPS coordinate of the second device when input receiving unit 210 receives the second notification. Then, authentication unit 240 may be configured to authorize the execution of the second use when a distance between the first location and the second location calculated based on the first GPS coordinate and the second GPS coordinate is within a predetermined range.

By way of another example, but not limitation, location determination unit 220 may be configured to identify first cell information of a cellular network accessed by the first device when input receiving unit 210 receives the first notification, and identify second cell information of the cellular network accessed by the second device when input receiving unit 210 receives the second notification. Then, authentication unit 240 may be configured to authorize the execution of the second use when a distance between the first location and the second location calculated based on the first cell information and the second cell information is within a predetermined range.

By way of yet another example, but not limitation, location determination unit 220 may be configured to identify a first cell of the cellular network in which the first device is located when input receiving unit 210 receives the first notification, and identify a second cell of the cellular network in which the second device is located when input receiving unit 210 receives the second notification. Then, authentication unit 240 may be configured to authorize the execution of the second use when the second cell and the first cell are the same cell.

By way of still another example, but not limitation, location determination unit 220 may be configured to identify a first Wi-Fi access point accessed by the first device when input receiving unit 210 receives the first notification, and identify a second Wi-Fi access point accessed by the second device when input receiving unit 210 receives the second notification. Then, authentication unit 240 may be configured to authorize the execution of the second use when the second Wi-Fi access point and the first Wi-Fi access point are the same Wi-Fi access point.

Notice issuing unit 250 may be configured to issue a notice suggesting purchase of the application to the second device, when authentication unit 240 determines not to authorize the execution of the second use.

Location monitoring unit 260 may be configured to monitor movement of the second device when authentication unit 240 authorizes the execution of the second use.

In some embodiments, authentication unit 240 may be configured to determine whether the second device has moved beyond the predetermined range during the execution of the second use based at least in part on the monitoring of location monitoring unit 260, and disable the execution of the second use in response to determining that the second device has moved beyond the predetermined range.

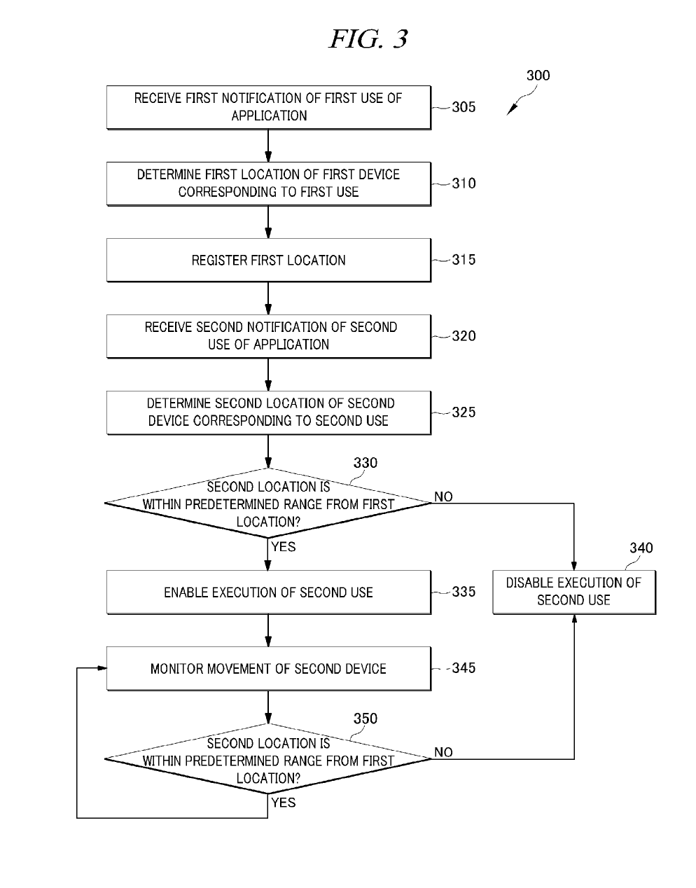

FIG. 3 shows an example flow diagram of a process 300 for a server implementing a location-based authentication scheme, arranged in accordance with at least some embodiments described herein.

Process 300 may be implemented in the server such as server 100 including input receiving unit 210, location determination unit 220, location registration unit 230, authentication unit 240, notice issuing unit 250 and location monitoring unit 260. Process 300 may include one or more operations, actions, or functions as illustrated by one or more blocks 305, 310, 315, 320, 325, 330, 335, 340, 345 and/or 350. Although illustrated as discrete blocks, various blocks may be divided into additional blocks, combined into fewer blocks, or eliminated, depending on the desired implementation. Processing may begin at block 305.

At block 305 (Receive First Notification of First Use of Application), server 100 (e.g., input receiving unit 210) may receive a first notification of a first use of an application. By way of example, but not limitation, the first use may include initially downloading the application from server 100 to a first device (e.g., device 110 or 120), initially installing the application on the first device, or initially executing the application on the first device. Processing may continue from block 305 to block 310.

At block 310 (Determine First Location of First Device Corresponding to First Use), server 100 (e.g., location determination unit 220) may determine a first location of the first device corresponding to the first use. By way of example, but not limitation, server 100 may identify a first GPS coordinate of the first device, identify first cell information of a cellular network accessed by the first device, identify a first cell of the cellular network in which the first device is located, and/or identify a first Wi-Fi access point accessed by the first device, when receiving the first notification. Processing may continue from block 310 to block 315.

At block 315 (Register First Location), server 100 (e.g., location registration unit 230) may register or store therein the first location. Processing may continue from block 315 to block 320.

At block 320 (Receive Second Notification of Second Use of Application), server 100 (e.g., input receiving unit 210) may receive a second notification of a second use of the application. By way of example, but not limitation, the second use may include executing the application on a second device (e.g., device 110 or 120). Those skilled in the art will appreciate that the first device and the second device may be identical to each other in some embodiments. Processing may continue from block 320 to block 325.

At block 325 (Determine Second Location of Second Device Corresponding to Second Use), server 100 (e.g., location determination unit 220) may determine a second location of the second device corresponding to the second use. By way of example, but not limitation, server 100 may identify a second GPS coordinate of the second device, identify second cell information of the cellular network accessed by the second device, identify a second cell of the cellular network in which the second device is located, and/or identify a second Wi-Fi access point accessed by the second device, when receiving the second notification. Processing may continue from block 325 to decision block 330.

At decision block 330 (Second Location is within Predetermined Range from First Location?), server 100 (e.g., authentication unit 240) may determine whether the second location is within a predetermined range from the first location. By way of example, but not limitation, server 100 may calculate a distance between the first location and the second location based at least in part on the first GPS coordinate and the second GPS coordinate, and determine whether the calculated distance is within the predetermined range. By way of another example, but not limitation, server 100 may calculate the distance between the first location and the second location based at least in part on the first cell information and the second cell information, and determine whether the calculated distance is within the predetermined range. By way of yet another example, but not limitation, server 100 may determine whether the second cell and the first cell are the same cell. In such cases, server 100 may determine that the second location is within the predetermined range from the first location when the second cell and the first cell are the same cell. By way of still another example, but not limitation, server 100 may determine whether the second Wi-Fi access point and the first Wi-Fi access point are the same Wi-Fi access point. In such cases, server 100 may determine that the second location is within the predetermined range from the first location when the second Wi-Fi access point and the first Wi-Fi access point are the same Wi-Fi access point. When it is determined that the second location is within the predetermined range from the first location, processing may continue from decision block 330 to block decision 335. Otherwise, processing may continue from decision block 330 to block 340.

At block 335 (Enable Execution of Second Use), server 100 (e.g., authentication unit 240) may enable execution of the second use. Processing may continue from block 335 to decision block 345.

At block 340 (Disable Execution of Second Use), server 100 (e.g., authentication unit 240) may disable the execution of the second use. In some embodiments, server 100 (e.g., notice issuing unit 250) may provide the second device with a notice suggesting purchase of the application.

At block 345 (Monitor Movement of Second Device), server 100 (e.g., location monitoring unit 260) may monitor movement of the second device. Processing may continue from block 345 to decision block 350.

At decision block 350 (Second Location is within Predetermined Range from First Location?), server 100 (e.g., authentication unit 240) may determine whether the monitored movement of the second device has extended beyond the predetermined range during the execution of the second use. That is, server 100 may determine whether the second device stays within the predetermined range from the first location during the execution of the second use. When it is determined that the second location is still within the predetermined range from the first location, processing may continue from decision block 350 to block decision 345. Otherwise, processing may continue from decision block 350 to block 340.

As such, server 100 may provide the location-based authentication scheme for allowing a user of the first and second devices to use the application in a limited area.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

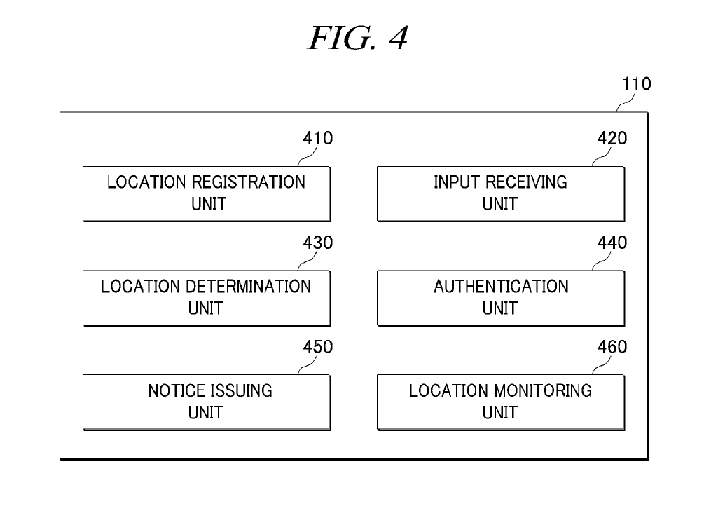

FIG. 4 shows a schematic block diagram illustrating an example architecture of a device 110 for implementing a location-based authentication scheme, arranged in accordance with at least some embodiments described herein.

In some embodiments, device 110 may be provided with an application from a server (e.g., server 100), while conducting location-based authentication independently of server 100. Although the below description describes the example embodiments with reference to device 110 for simplicity and ease of explanation, those skilled in the art will appreciate that the illustrated structures, operations, actions, and/or functions may also be applicable to device 120.

As depicted in FIG. 4, device 110 may include a location registration unit 410, an input receiving unit 420, a location determination unit 430, an authentication unit 440, a notice issuing unit 450 and a location monitoring unit 460. Although illustrated as discrete components, various components may be divided into additional components, combined into fewer components, or eliminated while being contemplated within the scope of the disclosed subject matter. It will be understood by those skilled in the art that each function and/or operation of the components may be implemented, individually and/or collectively, by a wide range of hardware, software, firmware, or virtually any combination thereof.

Location registration unit 410 may be configured to register a first location of device 110, associated with the application. In some embodiments, location registration unit 410 may receive information regarding the first location from server 100, and register or store therein the first location based at least in part on the received information. In some alternative embodiments, location registration unit 410 may register the first location as a location of device 110 when at least one of initially downloading the application from server 100 to device 110, initially installing the application on device 110, or initially executing the application on device 110 is performed, depending on the desired implementation.

Input receiving unit 420 may be configured to receive from a user of device 110 a request to authorize execution of the application.

Location determination unit 430 may be configured to determine a second location of device 110 when input receiving unit 420 receives the request. By way of example, but not limitation, location determination unit 430 may determine the second location based at least in part on GPS information, network cell information, and/or Wi-Fi access point information. In some embodiments, location determination unit 430 may be further configured to determine the first location when device 110 initially downloads the application from server 100, initially installs the application, or initially executes the application, depending on the desired implementation.

Authentication unit 440 may be configured to authorize execution of the application based at least in part on the first location of device 110 registered by location registration unit 410 and the second location of device 110 determined by location determination unit 430.

By way of example, but not limitation, location determination unit 430 may be configured to determine the second location of device 110 based at least in part on a GPS coordinate of device 110 when input receiving unit 420 receives the request. Then, authentication unit 440 may be configured to calculate a distance between the first location and the second location based at least in part on the GPS (Global Positioning System) coordinate of device 110, and authorize execution of the second use when the distance is within a predetermined range.

By way of another example, but not limitation, location determination unit 430 may be configured to determine the second location of device 110 based at least in part on cell information of a cellular network accessed by device 110 when input receiving unit 420 receives the request. Then, authentication unit 440 may be configured to calculate the distance between the first location and the second location based at least in part on the cell information, and authorize execution of the second use when the distance is within the predetermined range.

By way of yet another example, but not limitation, location determination unit 430 may be configured to identify a second cell of the cellular network in which device 110 is located when input receiving unit 420 receives the request. Then, authentication unit 440 may be configured to authorize execution of the second use when the second cell and a first cell associated with the first location are the same cell.

By way of still another example, but not limitation, location determination unit 430 may be configured to identify a second Wi-Fi access point accessed by device 110 when input receiving unit 420 receives the request. Then, authentication unit 440 may be configured to authorize execution of the second use when the second Wi-Fi access point and a first Wi-Fi access point associated with the first location are the same Wi-Fi access point.

Notice issuing unit 450 may be configured to issue a notice suggesting purchase of the application when authentication unit 440 determines that the second location is not within a predetermined range from the first location, i.e., when authentication unit 440 does not authorize the execution of the application. In some embodiments, the notice may be displayed on a display (not shown) of device 110.

Location monitoring unit 460 may be configured to monitor movement of device 110 when authentication unit 440 authorizes the execution of the application.

In some embodiments, authentication unit 440 may be configured to determine whether device 110 has moved beyond the predetermined range during the execution of the second use based at least in part on the monitoring of location monitoring unit 460, and disable the execution of the second use when determining that device 110 has moved beyond the predetermined range during the execution of the application.

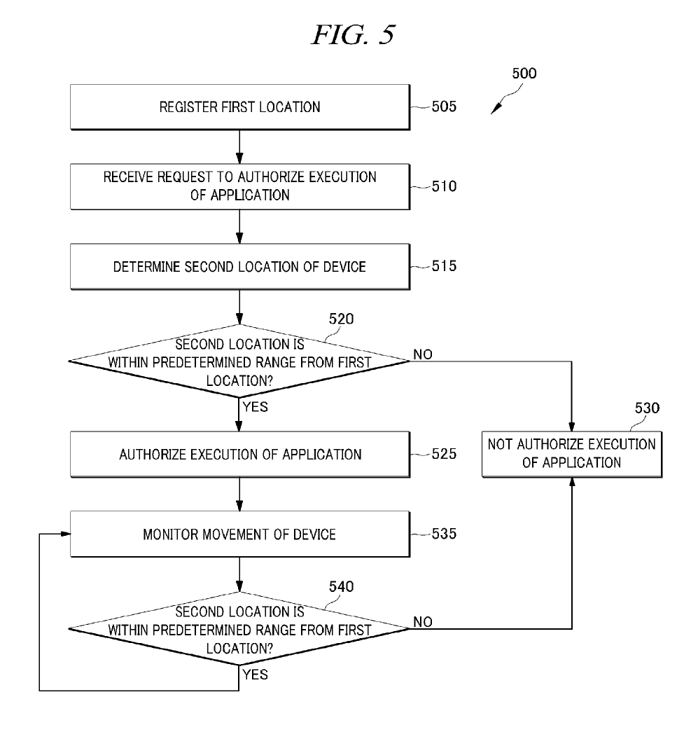

FIG. 5 shows an example flow diagram of a process 500 for a device implementing a location-based authentication scheme, arranged in accordance with at least some embodiments described herein.

Process 500 may be implemented in the device such as device 110 including location registration unit 410, input receiving unit 420, location determination unit 430, authentication unit 440, notice issuing unit 450 and location monitoring unit 460. Process 500 may include one or more operations, actions, or functions as illustrated by one or more blocks 505, 510, 515, 520, 525, 530, 535 and/or 540. Although illustrated as discrete blocks, various blocks may be divided into additional blocks, combined into fewer blocks, or eliminated, depending on the desired implementation. Processing may begin at block 505.

At block 505 (Register First Location), device 110 (e.g., location registration unit 410) may register a first location, which may be associated with an application. In some embodiments, device 110 may receive information regarding the first location from server 100, and register the first location based at least in part on the received information. In some alternative embodiments, device 110 may register the first location as a location of device 110 when at least one of initially downloading the application from server 100 to device 110, initially installing the application on device 110, or initially executing the application on device 110 is performed, depending on the desired implementation. Processing may continue from block 505 to block 510.

At block 510 (Receive Request to Authorize Execution of Application), device 110 (e.g., input receiving unit 420) may receive from a user of device 110 a request to authorize execution of the application. Processing may continue from block 510 to block 515.

At block 515 (Determine Second Location of Device), device 110 (e.g., location determination unit 430) may determine a second location of device 110 when receiving the request to authorize execution of the application. By way of example, but not limitation, device 110 may identify a GPS coordinate of device 110, identify cell information of a cellular network accessed by device 110, identify a second cell of the cellular network in which device 110 is located, and/or identify a second Wi-Fi access point accessed by device 110 when receiving the request. Processing may continue from block 515 to decision block 520.

At decision block 520 (Second Location is within Predetermined Range from First Location?), device 110 (e.g., authentication unit 440) may determine whether its second location is within a predetermined range from the first location. By way of example, but not limitation, device 110 may calculate a distance between the first location and the second location based at least in part on the GPS coordinate of device 110, and determine whether the distance is within the predetermined range. By way of another example, but not limitation, device 110 may calculate the distance between the first location and the second location based at least in part on the cell information of device 110, and determine whether the distance is within the predetermined range. By way of yet another example, but not limitation, device 110 may determine whether the second cell and a first cell associated with the first location are the same cell. By way of still another example, but not limitation, device 110 may determine whether the second Wi-Fi access point and a first Wi-Fi access point associated with the first location are the same Wi-Fi access point. When it is determined that the second location is within the predetermined range from the first location, processing may continue from decision block 520 to block decision 525. Otherwise, processing may continue from decision block 520 to block 530.

At block 525 (Authorize Execution of Application), device 110 (e.g., authentication unit 440) may authorize execution of the application. Processing may continue from block 525 to decision block 535.

At block 530 (Not Authorize Execution of Application), device 110 (e.g., authentication unit 440) may opt to not authorize execution of the application. In some embodiments, device 110 (e.g., notice issuing unit 450) may issue a notice suggesting purchase of the application.

At block 535 (Monitor Movement of Device), device 110 (e.g., location monitoring unit 460) may monitor movement of device 110. Processing may continue from block 535 to decision block 540.

At decision block 540 (Second Location is within Predetermined Range from First Location?), device 110 (e.g., authentication unit 440) may determine whether device 110 has moved beyond the predetermined range during the execution of the application. That is, device 110 may determine whether device 110 stays within the predetermined range from the first location during the execution of the application. When it is determined that the second location is within the predetermined range from the first location, processing may continue from decision block 540 to block decision 535. Otherwise, processing may continue from decision block 540 to block 530.

As such, device 110 may provide the location-based authentication scheme for allowing the user of device 110 to use the application in a limited area.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

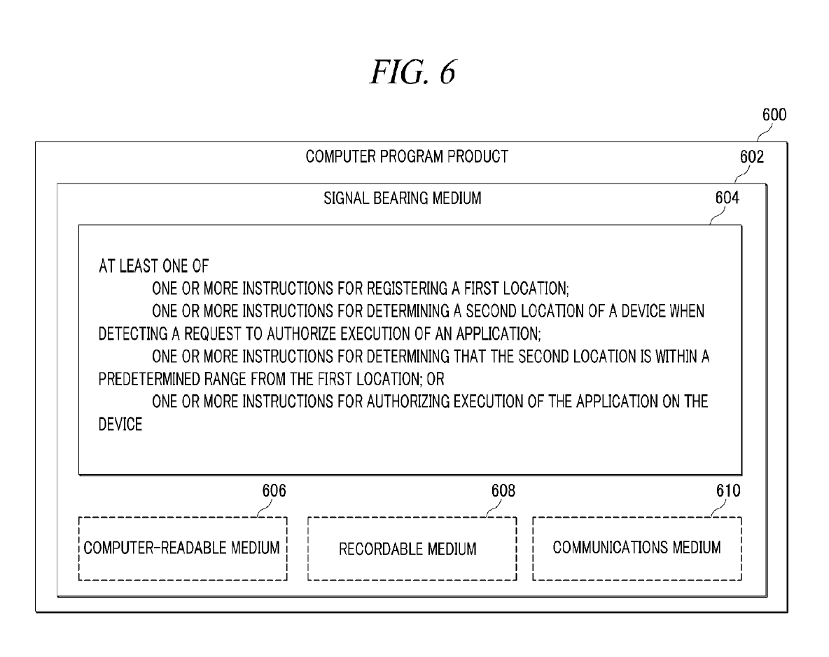

FIG. 6 illustrates an example computer program product 600 that may be utilized to implement a location-based authentication scheme, arranged in accordance with at least some embodiments described herein.

Program product 600 may include a signal bearing medium 602. Signal bearing medium 602 may include one or more instructions 604 that, when executed by, for example, a processor, may provide the functionality described above with respect to FIGS. 1-5. By way of example, instructions 604 may include: one or more instructions for registering a first location; one or more instructions for determining a second location of a device when detecting a request to authorize execution of an application; one or more instructions for determining that the second location is within a predetermined range from the first location; or one or more instructions for authorizing execution of the application on the device. Thus, for example, referring to FIG. 2, serer 100 may undertake one or more of the blocks shown in FIG. 3 in response to instructions 604. Alternatively, for example, referring to FIG. 4, device 110 may undertake one or more of the blocks shown in FIG. 5 in response to instructions 604.

In some implementations, signal bearing medium 602 may encompass a computer-readable medium 606, such as, but not limited to, a hard disk drive, a CD, a DVD, a digital tape, memory, etc. In some implementations, signal bearing medium 602 may encompass a recordable medium 608, such as, but not limited to, memory, read/write (R/W) CDs, R/W DVDs, etc. In some implementations, signal bearing medium 602 may encompass a communications medium 610, such as, but not limited to, a digital and/or an analog communication medium (e.g., a fiber optic cable, a waveguide, a wired communications link, a wireless communication link, etc.). Thus, for example, program product 600 may be conveyed to one or more modules of server 100 or device 110 by an RF signal bearing medium 602, where the signal bearing medium 602 is conveyed by a wireless communications medium 610 (e.g., a wireless communications medium conforming with the IEEE 802.11 standard).

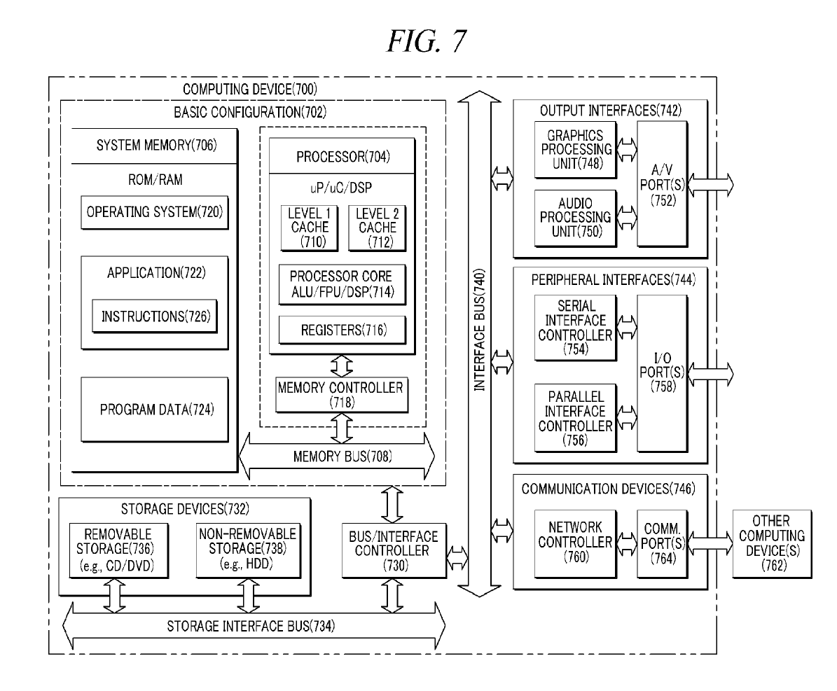

FIG. 7 is a block diagram illustrating an example computing device 700 that may be utilized to implement a location-based authentication scheme, arranged in accordance with at least some embodiments described herein.

In a very basic configuration 702, computing device 700 typically includes one or more processors 704 and a system memory 706. A memory bus 708 may be used for communicating between processor 704 and system memory 706.

Depending on the desired configuration, processor 704 may be of any type including but not limited to a microprocessor (μP), a microcontroller (μC), a digital signal processor (DSP), or any combination thereof. Processor 704 may include one or more levels of caching, such as a level one cache 710 and a level two cache 712, a processor core 714, and registers 716. An example processor core 714 may include an arithmetic logic unit (ALU), a floating point unit (FPU), a digital signal processing core (DSP Core), or any combination thereof. An example memory controller 718 may also be used with processor 704, or in some implementations memory controller 718 may be an internal part of processor 704.

Depending on the desired configuration, system memory 706 may be of any type including but not limited to volatile memory (such as RAM), non-volatile memory (such as ROM, flash memory, etc.) or any combination thereof. System memory 706 may include an operating system 720, one or more applications 722, and program data 724. Application 722 may include instructions 726 that may be arranged to perform the functions as described herein including the actions described with respect to the device 110 architecture as shown in FIG. 4 or including the actions described with respect to the flow charts shown in FIG. 5. In some examples, application 722 may be arranged to operate with program data 724 on an operating system 720 such that implementations for instructions for a computing system as described herein.

Computing device 700 may have additional features or functionality, and additional interfaces to facilitate communications between basic configuration 702 and any required devices and interfaces. For example, a bus/interface controller 730 may be used to facilitate communications between basic configuration 702 and one or more data storage devices 732 via a storage interface bus 734. Data storage devices 732 may be removable storage devices 736, non-removable storage devices 738, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 706, removable storage devices 736 and non-removable storage devices 738 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 700. Any such computer storage media may be part of computing device 700.

Computing device 700 may also include an interface bus 740 for facilitating communication from various interface devices (e.g., output devices 742, peripheral interfaces 744, and communication devices 746) to basic configuration 702 via bus/interface controller 730. Example output devices 742 include a graphics processing unit 748 and an audio processing unit 750, which may be configured to communicate to various external devices such as a display or speakers via one or more A/V ports 752. Example peripheral interfaces 744 include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via one or more I/O ports 758. An example communication device 746 includes a network controller 760, which may be arranged to facilitate communications with one or more other computing devices 762 over a network communication link via one or more communication ports 764.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method performed under control of a server, comprising:
receiving a first notification of a first use of an application;
determining a first location of a first device corresponding to the first use;
receiving a second notification of a second use of the application;
determining a second location of a second device corresponding to the second use;
determining that the second location is within a predetermined range from the first location;
enabling execution of the second use; and
responsive to determination that the second location is not within the predetermined range from the first location, providing the second device with a notice suggesting purchase of the application.

2. The method of claim 1, wherein the first use includes initially downloading the application from the server to the first device, initially installing the application on the first device, or initially executing the application on the first device.

3. The method of claim 1, wherein the second use includes executing the application on the second device.

4. The method of claim 1, further comprising:
registering the first location.

5. The method of claim 1, wherein the determining of the first location includes identifying a first GPS (Global Positioning System) coordinate of the first device when receiving the first notification, and the determining of the second location includes identifying a second GPS (Global Positioning System) coordinate of the second device when receiving the second notification, and
wherein the determining whether the second location is within the predetermined range from the first location includes calculating a distance between the first location and the second location based at least in part on the first GPS coordinate and the second GPS coordinate, and determining whether the distance is within the predetermined range.

6. The method of claim 1, wherein the determining of the first location includes identifying first cell information of a cellular network accessed by the first device when receiving the first notification, and the determining of the second location includes identifying second cell information of the cellular network accessed by the second device when receiving the second notification, and
wherein the determining whether the second location is within the predetermined range from the first location includes calculating a distance between the first location and the second location based at least in part on the first cell information and the second cell information, and determining whether the distance is within the predetermined range.

7. The method of claim 1, wherein the determining of the first location includes identifying a first cell of a cellular network in which the first device is located when receiving the first notification, and the determining of the second location includes identifying a second cell of the cellular network in which the second device is located when receiving the second notification, and
wherein the determining whether the second location is within the predetermined range from the first location includes determining whether the first cell and the second cell are the same cell.

8. The method of claim 1, wherein the determining of the first location includes identifying a first Wi-Fi access point accessed by the first device when receiving the first notification, and the determining of the second location includes identifying a second Wi-Fi access point accessed by the second device when receiving the second notification, and
wherein the determining whether the second location is within the predetermined range from the first location includes determining whether the first Wi-Fi access point and the second Wi-Fi access point are the same Wi-Fi access point.

9. (canceled)

10. The method of claim 1, further comprising:
monitoring movement of the second device after enabling the execution of the second use;
determining whether the second device has moved beyond the predetermined range during the execution of the second use; and
disabling the execution of the second use in response to determining that the second device has moved beyond the predetermined range.

11. The method of claim 1, wherein the second device is identical to the first device.

12. A method performed under control of a device, comprising:
registering a first location;
receiving a request to authorize execution of an application;
determining a second location of the device;
determining that the second location is within a predetermined range from the first location;
authorizing execution of the application; and
issuing a notice suggesting purchase of the application when determining that the second location is not within the predetermined range from the first location.

13. The method of claim 12, wherein the first location is a location of the device when at least one of initially downloading the application from a server to the device, initially installing the application on the device, or initially executing the application on the device is performed.

14. The method of claim 12, further comprising:
receiving information regarding the first location from a server.

15. The method of claim 12, wherein the determining of the second location includes identifying a GPS (Global Positioning System) coordinate of the device when receiving the request, and
wherein the determining whether the second location is within the predetermined range from the first location includes calculating a distance between the first location and the second location based at least in part on the GPS coordinate, and determining whether the distance is within the predetermined range.

16. The method of claim 12, wherein the determining of the second location includes identifying cell information of a cellular network accessed by the device when receiving the request, and
wherein the determining whether the second location is within the predetermined range from the first location includes calculating a distance between the first location and the second location based at least in part on the cell information, and determining whether the distance is within the predetermined range.

17. The method of claim 12, wherein the determining of the second location includes identifying a second cell of a cellular network in which the device is located when receiving the request, and
wherein the determining whether the second location is within the predetermined range from the first location includes determining whether the second cell and a first cell associated with the first location are the same cell.

18. The method of claim 12, wherein the determining of the second location includes identifying a second Wi-Fi access point accessed by the device when receiving the request, and
wherein the determining whether the second location is within the predetermined range from the first location includes determining whether the second Wi-Fi access point and a first Wi-Fi access point associated with the first location are the same Wi-Fi access point.

19. (canceled)

20. The method of claim 12, further comprising:
monitoring movement of the device after authorizing the execution of the application;
determining whether the device has moved beyond the predetermined range during the execution of the application; and
disabling the execution of the application in response to determining that the device has moved beyond the predetermined range.

21. A server for providing location-based authentication, comprising:
an input receiving unit configured to receive a first notification of a first use of an application and a second notification of a second use of the application;
a location determination unit configured to determine a first location of a first device corresponding to the first use and to determine a second location of a second device corresponding to the second use;
an authentication unit configured to authorize execution of the second use based at least in part on the first location and the second location; and
a notice issuing unit configured to issue a notice suggesting purchase of the application when the authentication unit determines not to authorize the execution of the second use.

22. The server of claim 21, wherein the first use includes initially downloading the application from the server to the first device, initially installing the application on the first device, or initially executing the application on the first device.

23. The server of claim 21, wherein the second use includes executing the application on the second device.

24. The server of claim 21, further comprising:
a location registration unit configured to register the first location.

25. The server of claim 21, wherein the location determination unit is further configured to identify a first GPS (Global Positioning System) coordinate of the first device when the input receiving unit receives the first notification and identify a second GPS (Global Positioning System) coordinate of the second device when the input receiving unit receives the second notification, and
wherein the authentication unit is further configured to authorize the execution of the second use when a distance between the first location and the second location calculated based on the first GPS coordinate and the second GPS coordinate is within a predetermined range.

26. The server of claim 21, wherein the location determination unit is further configured to identify first cell information of a cellular network accessed by the first device when the input receiving unit receives the first notification and identify second cell information of the cellular network accessed by the second device when the input receiving unit receives the second notification, and
wherein the authentication unit is further configured to authorize the execution of the second use when a distance between the first location and the second location calculated based on the first cell information and the second cell information is within a predetermined range.

27. The server of claim 21, wherein the location determination unit is further configured to identify a first cell of a cellular network in which the first device is located when the input receiving unit receives the first notification and identify a second cell of the cellular network in which the second device is located when the input receiving unit receives the second notification, and
wherein the authentication unit is further configured to authorize the execution of the second use when the first cell and the second cell are the same cell.

28. The server of claim 21, wherein the location determination unit is further configured to identify a first Wi-Fi access point accessed by the first device when the input receiving unit receives the first notification and identify a second Wi-Fi access point accessed by the second device when the input receiving unit receives the second notification, and
wherein the authentication unit is further configured to authorize the execution of the second use when the first Wi-Fi access point and the second Wi-Fi access point are the same Wi-Fi access point.

29. (canceled)

30. The server of claim 21, further comprising:
a location monitoring unit configured to monitor movement of the second device when the authentication unit authorizes the execution of the second use,
wherein the authentication unit is further configured to determine whether the second device has moved beyond the predetermined range during the execution of the second use, and disable the execution of the second use in response to determining that the second device has moved beyond the predetermined range.

31. The server of claim 21, wherein the second device is identical to the first device.

32. The server of claim 21, wherein the server provides the application to the first device and the second device.

33-41. (canceled)
